(19) United States
(12) Patent Application Publication
(10) Pub. No.: US 2008/0257881 A1
(43) Pub. Date: Oct. 23, 2008

(54) High-Frequency Heating Device

(76) Inventors: Namik Yilmaz, Istanbul (TR); Cem Kural, Istanbul (TR)

Correspondence Address: VENABLE, CAMPILLO, LOGAN & MEANEY, P.C., 1938 E. OSBORN RD, PHOENIX, AZ, 85016-7234, US

(21) Appl. No.: 10/597,338

(22) PCT Filed: Jan. 27, 2005
(86) PCT No.: PCT/IB2005/050363

§ 371 Date: Jul. 20, 2006

(30) Foreign Application Priority Data
Jan. 28, 2004 (TR) 2004/00154

(51) Int. Cl. H05B 6/66

(52) U.S. Cl. 219/702

(57) ABSTRACT

The high-frequency heating device, the subject of the present invention, is driven by an inverter and, by reducing the power losses in the mentioned inverter the operating efficiency is increased.

This invention relates to a high-frequency heating device with an increased operating efficiency wherein a magnetron driven by an inverter is utilized.

High-frequency heating devices, such as microwave ovens, microwave laundry dryers etc, are directly powered by the energy source via a transformer or by using an inverter circuit. Because the magnetron is powered by high-frequency switching currents, high-frequency heating devices that are powered by using an inverter circuit, operate at a lower efficiency.

The prior art document European Patent no. EP 0279514 describes a heating device comprising a magnetron powered by an inverter. By using the transistors added to the inverter circuit, it is achieved that the anode and inverter circuits of the magnetron, and a heater that is activated as the filament is turned on, are powered by a single power source.

Another prior art document, European Patent no. EP 0493604, describes a heating device comprising a magnetron powered by an inverter. By directing the inverter circuit through a control unit, it is achieved that the frequency of the resonance circuit coincides with the frequency of the control circuit at the time of starting and that the magnetron is turned on faster.

The object of the present invention is the realization of a high-frequency heating device driven by an inverter, wherein the operating efficiency is increased by reducing the power loss that occurs in the inverter.

The high-frequency heating device designed to fulfill the objective of the present invention is illustrated on the annexed drawings, where:

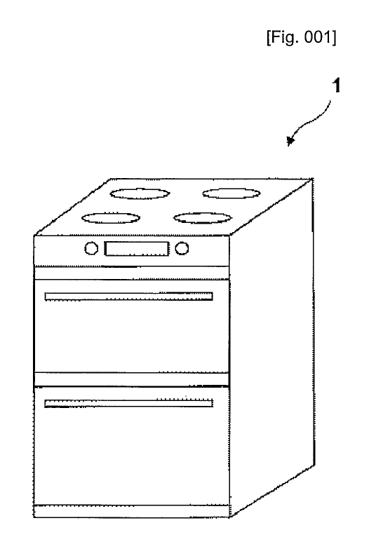

FIG. 1—is a schematic representation of a high-frequency heating device.

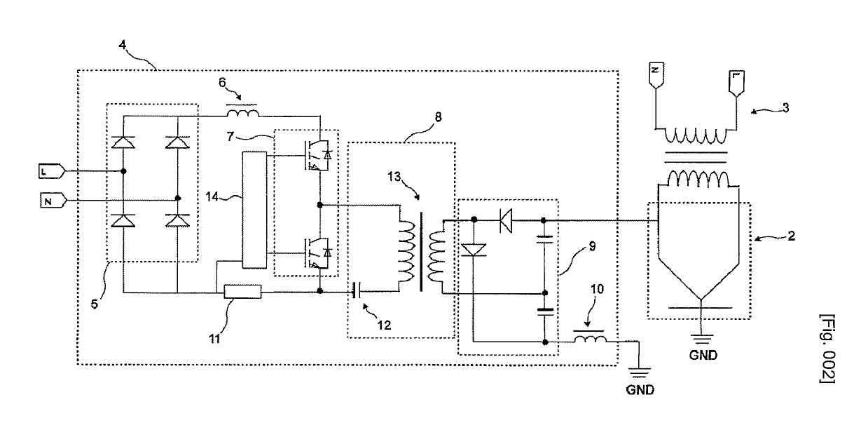

FIG. 2—is a schematic representation of an inverter and of a magnetron.

Parts shown on figures are numbered as follows:
1. High-frequency heating device
2. Magnetron
3. Filament circuit
4. Inverter
5. Diode bridge
6. High frequency filter
7. Power switching circuit
8. Resonant circuit
9. Wave multiplexer
10. Low pass filter
11. Current sensing resistor
12. Resonant capacitor
13. Resonant transformer
14. Control unit

The high-frequency heating device (1), the subject of the present invention, comprises a magnetron (2) generating microwave energy, a filament circuit (3) that is powered preferably through the network by a high frequency power supply or by a conventional transformer and, an inverter (4) enabling the magnetron (2) to be powered by high-frequency rectified voltage via the energy obtained from the network.

The inverter (4) comprises a diode bridge (5) providing that the alternative current obtained from the network is converted to direct current, a high frequency filter (6) eliminating high-frequency noise from the voltage signal coming from the diode bridge (5), a power switching circuit (7) wherein the direct voltage coming from the high frequency filter (6) is converted to square-wave voltage, a current sensing resistor (11) which protects the switches in case of an excessive current and is used for power control, a resonant circuit (8) operated at a frequency above the resonant of the square-wave voltage coming from the power switching circuit (7), a wave multiplexer (9) whereby the voltage obtained from the high-frequency current coming from the resonant circuit (8) is multiplied by being raised and rectified, a low-pass filter (10) placed between the wave multiplexer (9) and the ground, providing that low-frequency noise is eliminated from the current without decreasing the voltage and that the current applied to the magnetron (2) is smoothed and, a control unit (14) which compares the current feedback obtained from the current sensing resistor (11) with the analog power reference and which switches the power switching circuit (7) according to the result of the comparison so as to feed the magnetron (2) at a constant power.

The resonant circuit (8) comprises a resonant transformer (13) and a resonant capacitor (12) which converts the square-wave voltage to a voltage similar to the sinusoidal voltage by transferring energy, if the frequency of the square-wave voltage is above the resonant value.

As the high-frequency heating device (1), subject to the present invention, is turned on, the filament circuit (3) is heated by the current and electrons start to be emitted from the tips of the filament circuit (3). At the same time, the emitted electrons are directed by the voltage applied to the magnetron (2) the voltage being of 4.5 kV with respect to ground and, it is achieved that the electrons are spread by vibrating them at a high frequency. The voltage that is obtained from the network in order to apply the desired high-frequency current to the magnetron (2) is processed by the inverter (4). By the diode bridge (5), the alternative current obtained from the network is converted to direct current. The voltage signal coming from the diode bridge (5) is passed through the high frequency filter (6) to eliminate high-frequency noise. The direct voltage coming from the high frequency filter (6) is converted to square-wave voltage via the power switching circuit (7). With the help of the resonant circuit (8) the structure of the output of the power switching circuit (7) is made similar to a sinusoidal wave. The high-frequency voltage coming from the resonant circuit (8) is rectified and doubled by the wave multiplexer (9). The current is applied to the magnetron (2) after being cleared off the low-frequency noise and smoothed by the low-pass filter (10) placed between the ground and the wave multiplexer (9).

In the inverter (4), the operating efficiency of the high-frequency heating device (i) is increased by changing the frequency of the current that is powering the magnetron (2), from a square-wave form to a sinusoidal form through placing a low-pass filter (10) between the ground and the wave multiplexer (9).

1. A high-frequency heating device (1) which comprises, a magnetron (2) generating microwave energy, a filament circuit (3), an inverter which ensures that the magnetron (2) is powered by high-frequency rectified voltage via the energy obtained from the network and, which incorporates a wave multiplexer (9) whereby the voltage obtained from the high-frequency current coming from the resonant circuit (8) is multiplied by being raised and rectified and characterized by an inverter (4) which includes a low-pass filter (10) placed between the wave multiplexer (9) and the ground, providing that low-frequency noise is eliminated from the current without decreasing the voltage and that the current applied to the magnetron (2) is smoothed.
